(19) United States
(12) Patent Application Publication
(10) Pub. No.: US 2026/0368501 A1
(43) Pub. Date: Nov. 19, 2026

(54) BAYES-ADAPTIVE REINFORCEMENT LEARNING FOR PERFORMING REASONING TASKS

(71) Applicant: Google LLC, Mountain View, CA (US)

(72) Inventors: Tze Way Eugene Ie, Los Altos, CA (US); Shenao Zhang, Evanston, IL (US); Yunxuan Li, San Jose, CA (US); Tianqi Liu, Jersey City, NJ (US); Yaqing Wang, Jersey City, NJ (US); Peter Ward Grabowski, Chester, NJ (US); Yinxiao Liu, Palo Alto, CA (US)

(21) Appl. No.: 19/679,134

(22) Filed: May 15, 2026

Related U.S. Application Data
(60) Provisional application No. 63/806,662, filed on May 15, 2025.

(51) Int. Cl. G06N 3/0475; G06N 3/042

(52) U.S. Cl. CPC G06N 3/0475; G06N 3/042

(57) ABSTRACT

Methods, systems, and apparatus for training a generative neural network are described. A system receives a prompt and obtains a corresponding ground truth response. Using the generative neural network, the system generates a plurality of candidate reasoning trajectories, each including a sequence of reasoning steps followed by a candidate response. For each reasoning step, a quality value is determined that measures an expected future reward for adding the current step. The system determines a weighting factor based on the deviation of an observed progress reward from a predicted progress reward. A weighted quality value is computed by combining the quality value and the weighting factor. The system trains the generative neural network using the weighted quality values computed for the reasoning steps across the candidate trajectories.

### CROSS-REFERENCE TO RELATED APPLICATION

This application claims priority to U.S. Provisional Patent Application No. 63/806,662, filed on May 15, 2025, the disclosure of which is hereby incorporated by reference in its entirety.

### BACKGROUND

This specification relates to performing reasoning tasks using a machine-learning model, such as a generative neural network.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

The parameters of a machine learning model can be determined through a training process based on training data that includes one or more training examples. For example, neural networks can be trained by updating the network parameters, including, e.g., weights and bias coefficients of the network layers of the neural network.

### SUMMARY

This specification describes methods, computer systems, and apparatus, including computer programs encoded on computer storage media, for training a generative neural network configured to generate a reasoning trajectory in response to a prompt. In particular, the reasoning task includes providing an output response to an input prompt. More specifically, the output response includes (1) a final response to the prompt and (2) a reasoning trajectory including one or more reasoning steps to yield the final response to the prompt.

Generative neural networks, such as language generation neural networks, can perform a variety of tasks, such as translation tasks, and arithmetic tasks, among many other tasks. Relevant to reasoning tasks, a language model can be used to generate a response to a prompt (e.g., a question). The response to the prompt can be provided as a text sequence, for example, in the form of a yes/no binary answer, an answer providing one or more numerical values, an answer identifying one or more objects or events, an answer identifying planned routes or actions, and so on. The response to the query may be used by a human or a computer system in many ways. For example, the answer and the reasoning trajectory may be useful in themselves, or they may be used to provide a warning and/or to control the motions of one or more robotic agents or objects. In some implementations, the prompt can be a natural language query relating to an environment, in particular, a real-world environment. The output response can be a natural language reply or natural language output statement that also relates to the environment. For example, the output response can provide information relating to the environment, in some implementations relating to or specifying actions to be taken in the environment.

In one innovative aspect, this specification describes a method for training generative neural network for performing a reasoning task. The method is implemented by a system including one or more computers.

The system generates a plurality of candidate reasoning trajectories in response to a prompt. Each candidate reasoning trajectory includes a respective sequence of reasoning steps following the prompt, and followed by a candidate response to the prompt.

For each reasoning step in each of the plurality of candidate trajectories, the system determines a quality value for the current reasoning step in the candidate trajectory. The quality value measures an expected future reward for adding the current reasoning step to reasoning steps that precede the current reasoning step in the candidate reasoning trajectory. The system determines a first weighting factor based on, for each of one or more of the reasoning steps that precede the current reasoning step in the candidate trajectory, a deviation of an observed progress reward from a predicted progress reward for the preceding reasoning step, wherein the observed progress reward measures a change in a likelihood of the generative neural network generating the ground truth response to the prompt caused by adding the preceding reasoning step to the candidate reasoning trajectory. The predicted progress reward measures a change in a likelihood of the generative neural network generating the candidate response to the prompt caused by adding the preceding reasoning step. More specifically, the observed progress reward measures a difference between (i) a first likelihood assigned by the generative neural network to generating the ground-truth response to the prompt by processing an input that includes the partial candidate reasoning trajectory before including the preceding reasoning step, and (ii) a second likelihood assigned by the generative neural network to generating the ground-truth response to the prompt by processing an input that includes the partial candidate reasoning trajectory after including the preceding reasoning step. The predicted progress reward measures a difference between (i) a first likelihood assigned by the generative neural network to generating the candidate response to the prompt by processing an input that includes the partial candidate reasoning trajectory before including the preceding reasoning step, and (ii) a second likelihood assigned by the generative neural network to generating the candidate response to the prompt by processing an input that includes the partial candidate reasoning trajectory after including the preceding reasoning step. The system computes a weighted quality value based at least on the quality value and the first weighting factor, and trains the generative neural network using the weighted quality values computed for the plurality of reasoning steps in the plurality of candidate trajectories. For example, the system can update the parameter values of the generative neural network using a policy gradient that optimizes an objective function that incorporates the weighted quality values.

In some implementations, to determine the quality value for the current reasoning step in the candidate trajectory, the system determines a first probability of the generative neural network for generating the candidate response given that the current reasoning step has been generated, determines a second probability of the generative neural network for generating the candidate response without the current reasoning step having been generated, determines a verification reward value that measures a quality of the reasoning steps predicted by the generative neural network relative to the ground-truth response, and computes the quality value based on the first probability, the second probability, and the verification reward.

In some implementations, the system determines a second weighting factor based on a likelihood of the generative neural network for generating the candidate response given the reasoning steps preceding the current reasoning step in the candidate reasoning trajectory, and computes the weighted quality value based on the quality value, the first weighting factor, and the second weighting factor.

In some implementations, the system generates at least one candidate reasoning trajectory that includes reflective reasoning steps. In particular, the system generates a reasoning step that returns to a previous state in the candidate reasoning trajectory, and generates a subsequent reasoning step at the previous state that is different from a reasoning step previously generated at that state.

This specification also provides a system including one or more computers and one or more storage devices storing instructions that when executed by the one or more computers, cause the one or more computers to perform the method described above.

This specification also provides one or more computer storage media storing instructions that when executed by one or more computers, cause the one or more computers to perform the training method described above.

The subject matter described in this specification can be implemented in particular implementations so as to realize one or more of the following advantages.

This specification provides techniques for training generative neural networks to perform complex reasoning tasks more effectively. The techniques enable a generative neural network to improve its reasoning capabilities by adaptively exploring alternative strategies and learning from discrepancies between predicted and observed outcomes. The resulting generative neural network supports reflective reasoning, such as backtracking and revising intermediate reasoning steps, which can improve generalization to novel prompts and enhance accuracy on complex tasks.

The described techniques employ several strategies to improve computational efficiency, which results in the improvement of the functions of the computer system, including requiring fewer computational resources (e.g., CPU cycles and memory) and faster execution of numerical operations involved in training and/or using a generative neural network for performing reasoning tasks.

In general, the techniques described herein leverage a Bayes-Adaptive Reinforcement Learning framework to train generative neural networks for reasoning. This framework allows the model to maintain multiple hypotheses in the reasoning process and to actively explore different reasoning paths to reduce this uncertainty and improve its ability to find optimal solutions. The disclosed techniques improve the performance and adaptability of generative neural networks when applied to tasks that require step-by-step reasoning. Rather than relying solely on static training data or fixed reasoning patterns, the techniques train the neural network to recognize when its assumptions may be incorrect and to revise its reasoning trajectory accordingly. This enables the model to operate more effectively, e.g., by providing correct reasoning trajectories with fewer trials, in dynamic or uncertain environments, where correct answers may not be directly inferable from previously seen training examples.

In implementations of the provided techniques, the system maintains a posterior distribution over candidate reasoning strategies for training the generative neural network. It dynamically adjusts its behavior by weighting and updating hypotheses based on observed reward signals. This approach allows the model to perform exploration even during inference, thereby improving its ability to generalize to novel problem instances that differ from training data.

Furthermore, the described techniques provide improvements on the functions of the computing system during the deployment and inference phases of the generative neural network by addressing the inefficiencies of conventional reasoning models. For example, conventional models, particularly when operating under high sampling temperatures, often degenerate into generating a high frequency of stylistic or unproductive self-reflections. These unproductive text sequences consume a large number of tokens without making actual progress toward the ground truth response, which can severely degrade inference latency, wastes memory bandwidth, and occupies unnecessary processor cycles.

The techniques described herein overcome these technical problems through the specific operations used to evaluate reasoning steps. For instance, by determining a weighting factor based on a deviation of an observed progress reward from a predicted progress reward, the system can effectively apply a penalty to candidate hypotheses that fail to match the expected progress. This mechanism allows the generative neural network to dynamically eliminate invalidated hypotheses on-the-fly. Because the model is trained to cut off these invalidated reasoning paths rather than generating long, unproductive sequences, it can reach the optimal reasoning trajectory using fewer total generated tokens. Generating fewer tokens directly translates to a reduction in the processor cycles and memory bandwidth required during deployment, thereby reducing the overall latency required to output the final response.

Additionally, the described process for reflective exploration provides further improvements to token efficiency. Even when conventional models attempt to backtrack or self-reflect, they often fail to effectively switch strategies, resulting in fragile chain-of-thought outputs that require excessive token generation before finally arriving at a correct answer. By configuring the generative neural network to generate a reflective reasoning step by returning to a previous state and generating a subsequent reasoning step that is different from the reasoning step previously generated, the system can enforce a highly efficient form of strategy switching. Instead of the model wasting computational time outputting repetitive logic or superficial reflections, this feature enables the system to perform a definitive switch to explore alternative reasoning paths. Consequently, the system can avoid the computational trap of generating lengthy, redundant reasoning paths and discover the optimal solution in a reduced period of the time, demonstrating superior token efficiency compared to standard Markovian reasoning models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example machine learning system that includes a generative neural network configured to generate an output in response to receiving an input prompt.

FIG. 2A illustrates an example process performed by a training system for training a generative neural network.

FIG. 2B illustrates an example of reflective reasoning trajectories traversing a sequence of reasoning states.

FIG. 2C illustrates an example didactic sequence task for evaluating test-time generalization.

FIG. 2D illustrates a conceptual comparison of problem-solving behaviors between a conventional reinforcement learning model and a Bayes-Adaptive reinforcement learning model.

FIG. 3 is a flow diagram of an example process for training a generative neural network to perform a reasoning task.

FIG. 4 illustrates the performance and token efficiency of the described Bayes-Adaptive reinforcement learning framework compared to baseline techniques.

Like reference numbers and designations in the various drawings indicate like elements.

### DETAILED DESCRIPTION

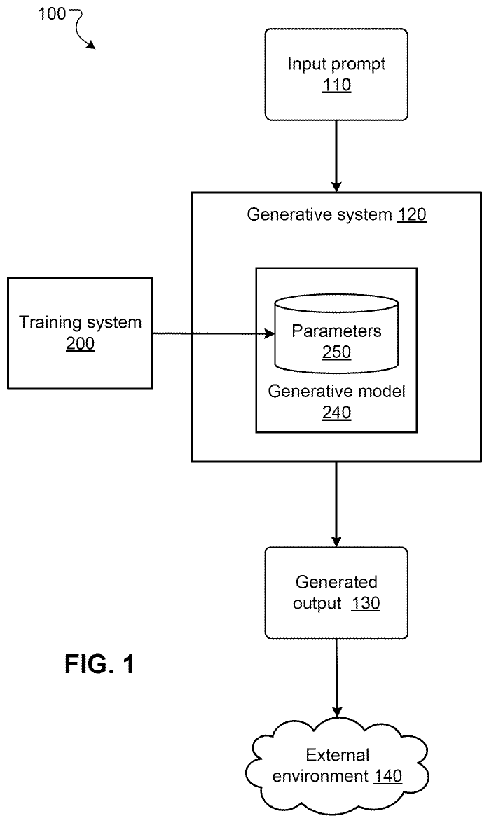

FIG. 1 shows an example machine learning system 100 that includes a generative neural network configured to generate an output in response to receiving an input prompt. The machine learning system 100 is an example of a system implemented as computer programs on one or more computers in one or more locations, in which the systems, components, and techniques described below can be implemented.

In one example, the system can be used for diagnosing a fault in a mechanical system operating in the real-world environment. The prompt can include observations about the mechanical system, e.g., from one or more sensors, and a question about the mechanical system. The observations and the question can be proposed to generate a language representation of the query. For example, the query may comprise a general question such as “Given the measurements from sensors A, B, and C, is the system working correctly?” or “Given the measurements of A, B, and C, what is wrong with the system?” or a specific request such as “Is there a fault with component X?” The output response can provide a final answer to the question and a reasoning trajectory leading to the final answer.

In another example, the environment can be an educational environment, e.g., the system can be deployed as part of an educational software program that assists a user in learning or practicing one or more corresponding skills. For example, the prompt can be a math word problem, and the output response includes the correct solution to the word problem and intermediate steps for reaching the correct solution. The output response can be provided to a student as a demonstration of how to solve the math problem, or be used as a grading tool to provide feedback on the student's practice.

In another example, the system can be used for natural language control of a task in a real-world environment. That is, the prompt can relate to the task, e.g., it may comprise a request to perform the task. The output response may be used to control e.g. a mechanical system (which may be referred to as a mechanical agent), or a computer system for performing the task. As one example, the prompt can include a high-level question, e.g. from a human, to perform a task, e.g., “What is the most cost-effective way to fabricate this component with our current equipment?” The output response includes a final answer specifying a planned procedure, and the reasoning steps for determining the planned procedure. The output response can be used to control one or more mechanical agents, e.g., robotic arms, to perform the planned procedure. In another example, the system can be used for generating or debugging computer code. The prompt can include a description of a desired code functionality or a code snippet with a bug. The output response can include the generated code implementing the functionality or the corrected code, along with a reasoning trajectory explaining the code generation or debugging steps. For instance, the prompt might be “Write a Python function that sorts a list of integers” or “Identify and fix the error in the following C++ code: [code snippet]”. The reasoning trajectory could detail the steps the model took to decompose the problem, select appropriate algorithms or data structures, and verify the correctness of the generated or corrected code.

In some implementations, the reasoning trajectory provides a human-interpretable explanation that can be used, e.g., by a user to 1) determine whether to perform the actions specified in the final answer in the output response or 2) later accessed when certain criteria are satisfied to evaluate the performance of the language model or to diagnose causes for errors occurring as a consequence of performing the actions specified in the responses generated by the language model.

In some implementations, the prompt can include multi-modal data. For example, the prompt can include two or more of text data, image data, audio data, video data, or sensor data. In some cases, the generative neural network can generate multi-modal reasoning trajectories. For example, the network can generate reasoning steps that include data in multiple modalities or in a modality different from the modality of the prompt.

In some implementations, the generative neural network is configured to receive a prompt to perform a task within a software environment, and generate commands executable in the software environment to carry out the task. For example, the generative neural network can generate a reasoning step that includes a call to an external software tool through an Application Programming Interface (API), and a subsequent reasoning step that comprises an output received from the external software tool in response to the API call.

The generative neural network can be a neural network configured to process an input to generate an output that includes a probability distribution over a set of tokens in a vocabulary, with the probability for each token representing the likelihood that the token immediately follows the input.

In one example, the vocabulary of the tokens can include any appropriate tokens that appear in natural language text, e.g., ASCII characters, words, word pieces, or differently distributed n-grams. For example, the vocabulary of text tokens can be fixed or can have been generated by applying an appropriate tokenizer, e.g., a byte pair encoding tokenizer or the SentencePiece tokenizer to a corpus of text.

The generative neural network can be an auto-regressive neural network. That is, the generative neural network auto-regressively generates an output sequence of tokens by generating each particular token in the output sequence conditioned on a current input sequence that includes any (e.g. all) tokens that precede the particular token in the output sequence, i.e., tokens that have already been generated for any previous positions in the output sequence that precede the particular position of the particular token.

More specifically, to generate a particular token at a particular position within a candidate output sequence, the neural network can process the current input sequence to generate a score distribution, e.g., a probability distribution, that assigns a respective score, e.g., a respective probability, to each token in the vocabulary. The neural network can then select, as the particular token, a token from the vocabulary using the score distribution. For example, the neural network can select the highest-scoring token or can sample, e.g., using nucleus sampling or another sampling technique, a token from the distribution.

The generative neural network can have any appropriate architecture. As a particular example, the generative neural network can be or comprise an auto-regressive Transformer-based neural network that includes (i) a sequence comprising a plurality of attention blocks that each apply a self-attention operation and (ii) an output subnetwork that processes an output of the last attention block to generate the score distribution for a next token.

Examples of Transformer-based neural network architectures include those described in J. Hoffmann, et al., Scaling language models: Methods, analysis & insights from training gopher. CoRR, abs/2112.11446, 2021; Colin Raffel, et al., Exploring the limits of transfer learning with a unified text-to-text transformer. ar Xiv preprint arXiv: 1910.10683, 2019; Daniel Adiwardana, et al., Towards a human-like open-domain chatbot. CoRR, abs/2001.09977, 2020; and Tom B Brown, et al. Language models are few-shot learners. arXiv preprint arXiv: 2005.14165, 2020. Generally, the Transformer-based neural network includes a sequence of attention blocks, and, during the processing of a given input sequence, each attention block in the sequence receives a respective input hidden state for each input token in the given input sequence. The attention block then updates at least the hidden state for the last token in a given input sequence at least in part by applying self-attention to generate a respective output hidden state for the last token. The input hidden states for the first attention block are embeddings of the input tokens in the input sequence and the input hidden states for each subsequent attention block are the output hidden states generated by the preceding attention block. The output subnetwork can process the output hidden state generated by the last attention block in the sequence for the last input token in the input sequence to generate the score distribution.

In this specification, a reasoning trajectory can refer to a sequence of intermediate logic operations or a structured path generated by a generative neural network to reach a final response to an input prompt. For instance, a candidate reasoning trajectory can include a respective sequence of reasoning steps generated after receiving a prompt, which is subsequently followed by a candidate final response to the prompt.

A reasoning step can refer to a discrete, intermediate action or an output generated by the neural network at a given stage of a reasoning trajectory. In particular, a reasoning trajectory can include one or more reasoning steps, e.g., steps that describe how a generative model decomposes a problem, selects mathematical algorithms, or interfaces with external software environments to yield the final response.

A reasoning state can represent the context or history of the reasoning trajectory up to a particular point in time, upon which the generative neural network conditions its subsequent reasoning step. For example, a state transition can occur by appending a newly generated reasoning step to the current reasoning state. As will be described below, in some cases, the system can engage in reflective reasoning by returning to a previous reasoning state in the candidate reasoning trajectory to generate a subsequent reasoning step that is different from the reasoning step previously generated at that particular state.

Furthermore, the terms “Bayes” or “Bayesian,” within the context of Bayes-Adaptive Reinforcement Learning, can refer to a probabilistic framework wherein the system maintains and updates a belief or a posterior distribution over candidate hypotheses (e.g., candidate Markov Decision Processes) based on observed data and progress rewards. By optimizing a Bayesian objective, the generative neural network can be trained to learn uncertainty-adaptive policies that leverage these belief updates to adaptively explore alternative strategies, evaluate discrepancies between predicted and observed outcomes, and/or dynamically determine when to engage in reflective exploration.

The machine learning system 100 includes a generative system 120 hosting a generative model 240 having a respective set of parameters 250. The generative model 240 can be a pre-trained language model, e.g., a large language model (LLM), configured to process inputs to generate an output that includes a probability distribution over a set of tokens in a vocabulary. As a particular example, the generative model 240 can include an auto-regressive Transformer-based neural network that includes (i) a sequence of attention blocks that each apply a self-attention operation and (ii) an output subnetwork that processes an output of the last attention block to generate a score distribution for a next token in an output sequence. Such generative neural networks can perform a variety of tasks, such as translation tasks and arithmetic tasks, among many other tasks. The response to a prompt can be provided as a text sequence, for example, in the form of a yes/no binary answer, an answer providing one or more numerical values, an answer identifying one or more objects or events, or an answer identifying planned routes or actions. The generated response can be used by a human or a computer system in many ways; for example, the answer and the reasoning trajectory may be useful in themselves, or they may be used to provide a warning and/or to control the motions of one or more robotic agents or objects.

In operation, the generative system 120 is configured to receive an input prompt 110 and process the input prompt 110 using the generative model 240 to produce a generated output 130. The input prompt 110 can include a text sequence, such as a natural language query, a math word problem, or a description of desired computer code functionality. In some implementations, the input prompt 110 can include multi-modal data. For example, the input prompt 110 can include two or more of text data, image data, audio data, video data, or sensor data. The generated output 130 includes an output response to the input prompt 110. More specifically, the output response can include (i) a final response to the input prompt 110 and (ii) a reasoning trajectory including one or more reasoning steps to yield the final response. The reasoning trajectory can provide a human-interpretable explanation or intermediate logic steps that detail how the generative model 240 decomposed the problem or selected appropriate algorithms. The human-interpretable explanation can be used, for example, by a user to determine whether to perform the actions specified in the final answer or accessed later to evaluate the performance of the language model or to diagnose causes for errors occurring as a consequence of performing the specified actions. In some cases, the generative model 240 can generate multi-modal reasoning trajectories, wherein at least one reasoning step includes data in a modality different from the modality of the input prompt 110.

The generative system 120 can interface with an external environment 140. The external environment 140 can refer to a physical, simulated, or computational setting in which the system 100 operates or to which the input prompt 110 relates. In some implementations, the external environment 140 is a real-world environment. For example, the input prompt 110 can include observations about a mechanical system operating in the external environment 140, e.g., from one or more sensors. The generated output 130 can provide a final answer specifying a planned procedure to diagnose a fault or control motions of one or more robotic agents in the real-world environment. In another example, the prompt can include a high-level question from a human to perform a task, such as determining the most cost-effective way to fabricate a component using current equipment. The output response includes a final answer specifying a planned procedure and the reasoning steps for determining the planned procedure, which can be used to control one or more mechanical agents, such as robotic arms, to perform the planned procedure. In yet another example, the external environment 140 can be an educational environment, where the prompt can be a math word problem. The generated output 130 is provided to a user as a demonstration of intermediate steps for reaching the correct solution to the word problem, or it can be used as a grading tool to provide feedback on a student's practice.

In some implementations, the external environment 140 can include a software environment. The generative model 240 can be configured to receive a prompt 110 to perform a task within the software environment and generate commands executable in the software environment to carry out the task. For example, a reasoning step in the generated output 130 can include a call to an external software tool through an Application Programming Interface (API) associated with the external environment 140, and a subsequent reasoning step can include an output received from the external software tool in response to the API call. As another example, the system can be used for generating or debugging computer code. The prompt can include a description of a desired code functionality, such as writing a Python function to sort a list of integers, or a code snippet with a bug, such as identifying and fixing an error in C++ code. The generated output 130 can include the generated code implementing the functionality or the corrected code, along with a reasoning trajectory detailing the steps the model took to decompose the problem, select appropriate algorithms or data structures, and verify the correctness of the code.

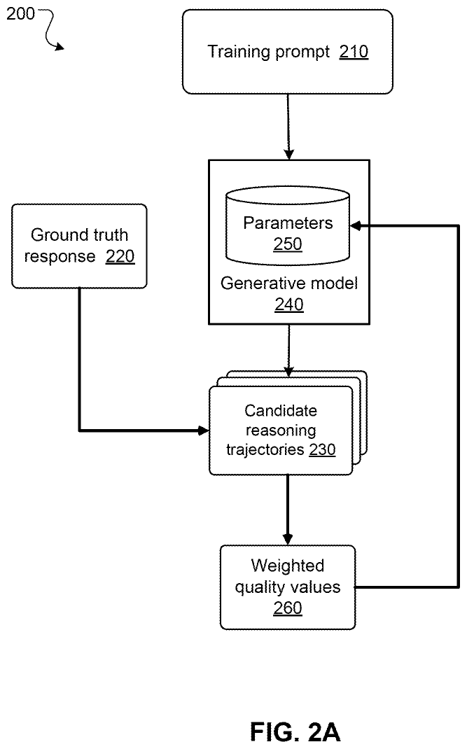

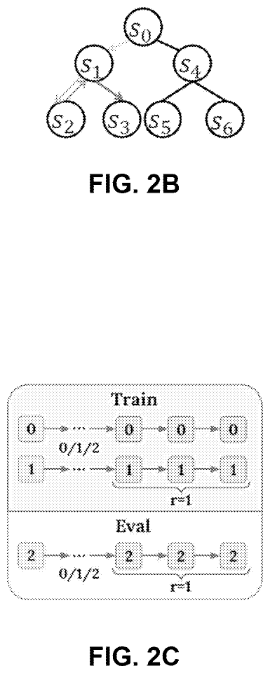

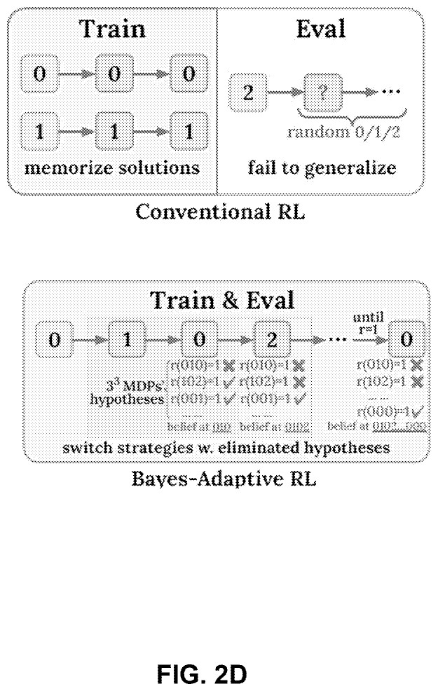

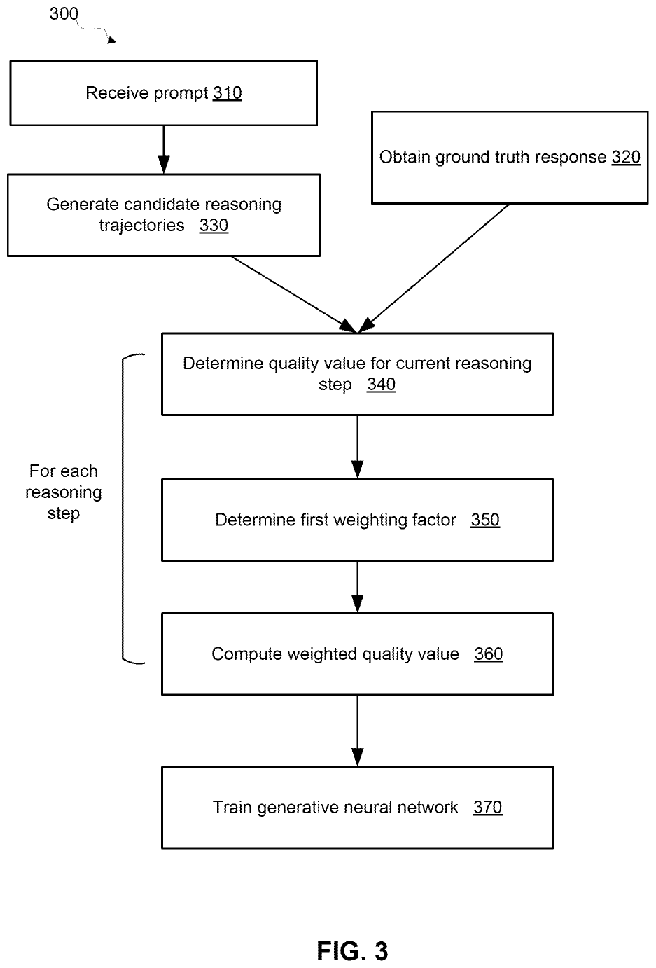

The machine learning system 100 further includes a training system 200 in data communication with the generative system 120. The training system 200 is configured to determine and update the values of the parameters 250 of the generative model 240 through a training process. Further details and examples of this training process and associated methods will be described below with reference to FIG. 2A, FIG. 2B, FIG. 2C, FIG. 2D, and FIG. 3. In general, the training system 200 trains the generative model 240 to perform complex reasoning tasks by generating candidate reasoning trajectories, evaluating those trajectories against predicted and observed progress rewards, and optimizing a Bayes-Adaptive Reinforcement Learning objective. This process can train the generative model 240 to adaptively explore alternative strategies, maintain a posterior distribution over candidate hypotheses, and engage in reflective reasoning, such as backtracking to previous reasoning states, thereby improving the model's ability to solve complex problems and generalize to novel prompts 110.

FIG. 2A illustrates a process performed by an example training system 200 for training the generative model 240. As shown in FIG. 2A, the training system 200 is configured to update the parameters 250 of the generative model 240 based on one or more training examples. For clarity of explanation, the operations described below focus on processing a single training example. In practice, the training system 200 can process multiple training examples concurrently or sequentially. For example, the training system 200 can sample a batch of training examples from the training data. The system can then compute the respective policy gradients for each of the training examples in the batch, and update the parameters 250 of the generative model 240 based on an accumulation or an average of the gradients across the batch.

At the start of the training process, the training system 200 receives a training prompt 210 for the generative model 240. In this specification, a training prompt can refer to an input sequence used during the training phase to condition the generative model, such as a natural language question or a mathematical word problem. In an illustrative example, the training prompt can be “Solve for x in the equation 2x+3=7”. The training system 200 also obtains a ground truth response 220 corresponding to the training prompt 210. The ground truth response can refer to a known, correct, or target output corresponding to the training prompt, such as the correct mathematical solution (e.g., “x=2”) or a verified, high-quality reasoning trajectory. The ground truth response 220 can be obtained from a curated dataset of human-annotated examples, generated by an expert computational system, or retrieved from an existing database of verified problem-solution pairs.

The training system 200 generates, using the generative model 240, a plurality of candidate reasoning trajectories 230 in response to the training prompt 210. In particular, the candidate reasoning trajectories can be generated using an inference process based on the current values of the parameters 250 of the generative model 240. The system can generate a plurality of candidate reasoning trajectories by performing multiple independent rollouts of the generative model 240 for the same training prompt 210, resulting in a diverse candidate set of answers associated with different reasoning paths.

Each candidate reasoning trajectory 230 can include a respective sequence of reasoning steps generated sequentially, followed by a respective candidate response to the training prompt 210. In some implementations, generating the plurality of candidate reasoning trajectories 230 includes generating at least one candidate reasoning trajectory that includes reflective reasoning steps. To generate the reflective reasoning steps, the generative model 240 can generate a reasoning step that returns to a previous state in the candidate reasoning trajectory, and subsequently generate a reasoning step at the previous state that is different from the reasoning step previously generated at that state. In the context of the generative model's output, “returning” to a previous state does not require deleting or erasing previously generated reasoning steps. Rather, the generative model 240 can generate a sequence of one or more text tokens including, e.g., a reflection phrase that invalidates the preceding exploration step and re-grounds the reasoning context in the logic of the previous state. For example, in natural language processing tasks, the generated tokens corresponding to a reflective step can include a phrase such as “Let's reconsider the previous step” or “Let's rethink the relationship.” By appending the newly generated tokens to the current sequence, the generative model 240 can update the overall reasoning state to effectively “return” the context to the previous state. This mechanism allows the generative model 240 to engage in self-reflection and adaptively explore alternative strategies during reasoning. Detailed examples of traversing such reflective reasoning states will be described below with reference to FIG. 2B. In some implementations, the reflective exploration behavior can be a capability that naturally arises as a result of the training process, rather than requiring explicit instructions within the prompt. In particular, by training the generative model using the Bayes-Adaptive reinforcement learning framework described above, the model is trained to optimize an expected return under a posterior distribution of candidate hypotheses. Consequently, the generative model can naturally learn to dynamically update its internal belief state and switch strategies when observed progress rewards deviate from predicted progress rewards, which physically manifests as the generation of these reflective reasoning steps.

In some implementations, generating the plurality of candidate reasoning trajectories 230 includes using decoding strategies to sample the reasoning steps and candidate responses. A decoding strategy can refer to a computational method used to select a next token from a score distribution generated by the generative model 240. For example, the generative model 240 can employ temperature sampling during the generation of the candidate reasoning trajectories to encourage exploration and diversity in the reasoning steps.

Temperature sampling can refer to a technique that adjusts the logits of the score distribution before applying a softmax function, thereby flattening or sharpening the distribution to increase or decrease the randomness of the selected tokens. In some cases, the temperature can be set to a high value, e.g., 1.0, during training. A higher sampling temperature can be beneficial because it can encourage the model to explore a wider variety of reasoning paths, preventing the policy from prematurely converging on a single, potentially suboptimal solution.

In some cases, the system can use a low sampling temperature to perform greedy decoding, e.g., using a sampling temperature of 0.0, to maximize exploitation of the learned policy. Greedy decoding selects the token with the highest predicted probability at each step, which removes randomness and causes the generative neural network to consistently output its most confident reasoning trajectory and final answer.

For each reasoning step in each of the plurality of candidate reasoning trajectories 230, the training system 200 determines a quality value for the current reasoning step in the candidate trajectory. The quality value measures an expected future reward for adding the current reasoning step to reasoning steps that precede the current reasoning step in the candidate reasoning trajectory 230. In some implementations, to determine the quality value for the current reasoning step, the training system 200 determines a first probability of the generative model 240 for generating the candidate response given that the current reasoning step has been generated. In some cases, the training system 200 can also determine a second probability of the generative model 240 for generating the candidate response without the current reasoning step having been generated. Furthermore, the training system 200 can determine a verification reward value that serves as an outcome-level reward. To compute the verification reward value, the training system 200 can compare the candidate response (e.g., the final answer reached at the end of the candidate reasoning trajectory) to the obtained ground-truth response 220. For example, the training system 200 can use a verifier to perform a matching operation, such as a regular expression match, between the candidate response and the ground-truth response to output a numerical score, such as a binary score of 1 for a correct match and 0 for an incorrect match. The training system 200 can compute the quality value based on the first probability, the second probability, and the verification reward. The first probability and the second probability parameterize the change in the likelihood of producing a candidate response induced by the current reasoning step, capturing whether the current reasoning step makes progress toward the generated answer. The verification reward can be used as an objective outcome evaluation, measuring the actual correctness of the resulting candidate response relative to the ground-truth response.

The training system 200 can determine a first weighting factor based on, for each of one or more of the reasoning steps that precede the current reasoning step in the candidate trajectory 230, a deviation of an observed progress reward from a predicted progress reward for the preceding reasoning step. The observed progress reward measures a change in a likelihood of the generative model 240 generating the ground truth response 220 to the training prompt 210 caused by adding the preceding reasoning step to the candidate reasoning trajectory 230. The predicted progress reward measures a change in a likelihood of the generative model 240 generating the candidate response to the training prompt 210 caused by adding the preceding reasoning step. In particular, the observed progress reward can measure a difference between (i) a first likelihood assigned by the generative neural network to generating the ground-truth response to the prompt by processing an input that includes the partial candidate reasoning trajectory before including the preceding reasoning step, and (ii) a second likelihood assigned by the generative neural network to generating the ground-truth response to the prompt by processing an input that includes the partial candidate reasoning trajectory after including the preceding reasoning step.

In some implementations, to determine the likelihood assigned by the generative neural network to generate a target sequence (such as the ground-truth response or the candidate response) given a current input sequence, the system can append the target sequence to the current input sequence. Because the generative neural network can operate auto-regressively, it can process the sequence to output a respective probability score for each individual token in the target sequence, conditioned on the preceding tokens. The system can then compute the overall likelihood of the target sequence by combining these individual token probability scores. For example, the system can calculate a joint probability by multiplying the individual token probabilities together. In some cases, to improve computational stability and avoid numerical underflow, the system can compute the likelihood by summing the log-probabilities of the individual tokens in the target sequence.

Furthermore, because the likelihood can be computed by evaluating the probabilities of tokens appended to an existing sequence, the system can improve computational efficiency by utilizing prefix caching, such as a Key-Value (KV) cache. By reusing the prefix cache generated during the initial generation of the candidate reasoning trajectories, the system can avoid the need to perform computationally expensive full re-rollouts from scratch when computing the changes in likelihood.

In some cases, maintaining a belief over multiple candidate hypotheses to determine the weighting factors can be formally modeled as an Epistemic Partially Observable Markov Decision Process (POMDP). In this specification, a “belief” can refer to a posterior distribution over multiple candidate hypotheses (such as candidate Markov Decision Processes) that a system maintains and updates based on observed data and progress rewards. In this formulation, the hidden state of the system can be modeled as a combination of a current text state (e.g., the current reasoning state) and an underlying Markov Decision Process (MDP) hypothesis. The generative model 240 can be trained to gather contextual information, such as progress rewards, to reduce the uncertainty regarding the underlying MDP hypothesis, thereby dynamically updating its internal belief state to accurately estimate posterior-weighted values for different reasoning paths.

The training system 200 can compute a weighted quality value 260 based at least on the previously determined quality value and the first weighting factor. In some implementations, computing the weighted quality value 260 further includes determining a second weighting factor. The second weighting factor is based on a likelihood of the generative model 240 for generating the candidate response given the reasoning steps preceding the current reasoning step in the candidate reasoning trajectory 230, and optionally, an appended end-of-thinking token, such as an answer-elicitation prompt. In such cases, the training system 200 computes the weighted quality value 260 based on the quality value, the first weighting factor, and the second weighting factor.

The training system 200 can train the generative model 240 using the weighted quality values 260 computed for the plurality of reasoning steps in the plurality of candidate reasoning trajectories 230. For example, the training system 200 can update the values of the parameters 250 of the generative model 240 using a policy gradient that optimizes an objective function incorporating the weighted quality values 260. A policy gradient can refer to an optimization algorithm that estimates the gradient of an expected reward objective with respect to the parameters of a model. To perform the updates, the training system can compute the gradient by multiplying gradients of the log-probabilities of the generated actions with the corresponding weighted quality values, and then adjust the parameters 250 in the direction of the gradient using an optimization algorithm, such as stochastic gradient descent, to increase the likelihood of generating high-reward reasoning trajectories.

In some implementations, when training the generative model 240 using the computed weighted quality values 260, the training system 200 can update a full set of parameters 250 of the generative neural network. Updating the full set of parameters can help the model capture the epistemic uncertainty required for reflective reasoning. In some implementations, the system can utilize other methods to estimate the posterior-weighted values, such as using value ensembles. For instance, capturing epistemic uncertainty can include fine-tuning an ensemble of state-action value functions, such as by fine-tuning multiple linear value heads on disjoint data subsets. In some cases, the system can apply Bayesian Low-Rank Adaptation (LoRA) to fine-tune a specialized subset of the parameters while holding the other parameters of the model fixed to their pre-trained values.

As an illustrative example of the processes described above, the training prompt 210 can be denoted as an initial state so, and the corresponding ground truth response 220 can be denoted as a target output sequence

$${y}_{{s}_{0}}^{*} .$$

When generating the plurality of candidate reasoning trajectories 230, the system can draw | [symbol] | chain-of-thought (CoT) rollouts of a policy π_{θ} on the prompt s₀ to form a candidate set of answers

$${\{ {y}_{{s}_{0}}^{{ℳ}_{i}} \}}_{i = 1}^{\vert ℳ \vert} ,$$

which are associated with a set of candidate hypotheses, such as Markov Decision Process (MDP) hypotheses.

Furthermore, for a current reasoning step at given a current history or reasoning state hₜ, the previously described quality value can be represented under a given candidate hypothesis [symbol] as a state-action value

$${Q}_{{ℳ}_{i}}^{π θ} ( {h}_{t} , {a}_{t} ) .$$

To compute the weighted quality value 260 (e.g., a posterior-weighted value), the system combines this state-action value with the first and second weighting factors.

The first weighting factor captures the consistency between observed progress rewards rₜ, and predicted progress rewards r [symbol] (s_{t′}, a_{t′}) for the candidate hypothesis. This can be expressed mathematically as:

$${\prod }_{{t}^{′} = 0}^{t - 1} exp ( - β \vert {r}_{{t}^{′}} - {r}_{{ℳ}_{i}} ( {s}_{{t}^{′}} , {a}_{{t}^{′}} ) \vert )$$

where β is a hyperparameter scaling the penalty for reward mismatches.

The second weighting factor captures the model's state-conditional belief in the plausibility of the candidate hypothesis. This can be expressed as:

$${π}_{θ} ( {y}_{{s}_{0}}^{{ℳ}_{i}} \vert {s}_{t} + \text{</} think > )$$

where </think> represents an end-of-thinking token or answer elicitation prompt appended to the state.

By summing over the candidate hypotheses alongside a ground-truth MDP [symbol] , the computation of the weighted quality value 260 equals the expected value of the state-action values across the hypotheses. Specifically, this satisfies

$${𝔼}_{ℳ} [ {Q}_{{ℳ}_{i}}^{{π}_{θ}} ( {h}_{t} , {a}_{t} ) ] = {\sum }_{i = 0}^{\vert ℳ \vert} {Q}_{{ℳ}_{i}}^{{π}_{θ}} ( {h}_{t} , {a}_{t} ) \cdot {π}_{θ} ( {y}_{{s}_{0}}^{{ℳ}_{i}} \vert {s}_{t} + \text{</} think > ) \cdot {\prod }_{{t}^{′} = 0}^{t - 1} exp ( - β \vert {r}_{{t}^{′}} - {r}_{{ℳ}_{i}} ( {s}_{{t}^{′}} , {a}_{{t}^{′}} ) \vert ) .$$

Furthermore, when training the generative model 240 using the computed weighted quality values 260, the training system 200 can update the values of the network parameters θ using a policy gradient. This policy gradient optimizes an objective function incorporating the weighted quality values 260, and can be calculated as:

$${∇}_{θ} 𝒥 = {𝔼}_{{s}_{θ} , {π}_{θ}} [ {\sum }_{t = 0}^{T - 1} {∇}_{θ} log {π}_{θ} ( {a}_{t} \vert {h}_{t} ) \cdot {𝔼}_{ℳ \sim p ( ℳ \vert 𝒟 , {h}_{t} )} [ {Q}_{{ℳ}_{i}}^{{π}_{θ}} ( {h}_{t} , {a}_{t} ) ] ]$$

where [symbol] represents the training data, T is the horizon, and p( [symbol] | [symbol] , hₜ) is the posterior distribution. To computationally evaluate the expectation operators in the equation, the system can use empirical averages over discrete samples. For example, the system can approximate the outer expectation over the initial states and the policy by sampling a batch of training prompts from the training data D and generating a finite set of candidate reasoning trajectories for each prompt. Similarly, the system can approximate the inner expectation over the posterior distribution of hypotheses by computing a weighted sum over the discrete set of candidate hypotheses associated with the sampled candidate answers, as described previously.

FIG. 2B illustrates an example of reflective reasoning trajectories traversing a sequence of reasoning states within a reasoning space. As shown in FIG. 2B, the reasoning space can be conceptually represented as a search tree, such as a binary search tree, having a plurality of nodes corresponding to reasoning states (e.g., s₀, s₁, s₂, s₃, s₄, s₅, and s₆). The initial state so can correspond to the input prompt, and the generative model can transition between states by generating sequential reasoning steps.

In the illustrated example, the generative model initially traverses from state so to state s₁, and subsequently to state s₂. The transition from s₁ to s₂ represents an initial exploration step. Following this exploration step, the generative model can exhibit a reflective exploration behavior. In particular, the generative model generates a reflective reasoning step that returns to the previous state s₁ from the state s₂ (represented by the arrow pointing from s₂ back to s₁). This reflective step signals a strategy switch. For example, in natural language processing tasks, such a reflective step can correspond to the generative model generating a language reflection phrase, such as “Let's reconsider the previous step” or “Let's rethink the relationship.”

After returning to the previous state s₁, the generative model subsequently generates a reasoning step at the previous state s₁ that is different from the reasoning step previously generated at that state. As shown in the figure, instead of transitioning to s₂ again, the generative model generates a different reasoning step that transitions from state s₁ to state s₃. This reflective exploration behavior enables the generative model to revisit a prior state and, informed by additional context, gathered rewards, or updated belief probabilities acquired during the initial exploration, alter its subsequent actions to explore alternative reasoning paths. Such strictly uncertainty-adaptive policies allow the system to dynamically stitch and switch strategies based on observed outcomes, ultimately yielding a more robust and accurate candidate reasoning trajectory.

FIG. 2C illustrates an example didactic sequence task for evaluating test-time generalization of a machine learning model, such as the generative neural network 240. The illustrated process represents reasoning tasks where the goal is not merely to memorize specific reasoning paths observed during training, but to provide generalized problem-solving capabilities to handle distribution shifts between training and evaluation datasets.

As shown in the upper portion of FIG. 2C, during a training phase, the system is presented with an initial state corresponding to a training prompt token, such as “0” or “1”. At each timestep, the generative model can select an action from an action space that includes a discrete set of tokens, for example, the tokens “0”, “1”, and “2”. The objective of the task is to consecutively repeat the initial prompt token a predetermined number of times, such as three times within a predetermined maximum horizon constraint, e.g., a predefined maximum timesteps, to receive a target progress reward, indicated in the figure as “r=1”. This specific horizon constraint provides the minimal length required to allow the model to exhaustively test all unique triplet combinations within the available action space if necessary.

For instance, if the training prompt token is “0”, the optimal candidate reasoning trajectory includes generating the sequence “0”, “0”, and “0”. Similarly, if the prompt token is “1”, the rewarding sequence includes generating “1”, “1”, and “1”.

Notably, in some cases, the training data does not include coverage for the token “2” functioning as a prompt token. As shown in the lower portion of FIG. 2C, during an evaluation or deployment phase, the trained policy is deployed and evaluated using a novel evaluation prompt token that was unseen during training, such as the token “2.” The objective remains consistent: the model is configured to generate the corresponding sequence, e.g., “2-2-2”, to achieve the target reward. This evaluation task tests whether the generative model has acquired the ability to dynamically determine when and how to switch to new strategies when confronted with unfamiliar evaluation prompts, rather than simply repeating the memorized sequences (e.g., “0-0-0” or “1-1-1”) learned during the training phase.

FIG. 2D illustrates a comparison of problem-solving behaviors between a conventional reinforcement learning model and a Bayes-Adaptive reinforcement learning model.

As shown on the left side of FIG. 2D, a generative model trained using conventional reinforcement learning tends to memorize specific solutions observed during a training phase. For instance, the conventional model learns to generate the specific sequence “0”, “0”, “0” when prompted with “0”, and “1”, “1”, “1” when prompted with “1”. However, when presented with an unfamiliar prompt during an evaluation phase, such as the prompt token “2”, the conventional model fails to generalize. Because conventional reinforcement learning yields a Markovian policy that does not adaptively update its context at previously visited states, the model randomly outputs tokens (e.g., randomly generating “0”, “1”, or “2”) and cannot reliably determine the new correct strategy.

Conversely, the right side of FIG. 2D illustrates the problem-solving behavior of a generative neural network trained using Bayes-Adaptive reinforcement learning. Under this framework, the generative neural network is trained to maintain a belief or a posterior distribution over multiple candidate hypotheses, referred to as MDP hypotheses. During exploration, if a partial reasoning trajectory generated by the model (e.g., the sequence “0-1-0”) is invalidated by an observed reward, the model updates its internal belief state (indicated in the figure as “belief at 010”) to reflect this outcome. The model dynamically eliminates the invalidated hypotheses by, for example, setting a reward mismatch penalty hyperparameter to infinity (β=∞), which forces a strictly binary weighting factor that zeros out any hypothesis having a predicted reward that does not match the observed reward. By applying this strict elimination, the model switches strategies to explore alternative paths (e.g., subsequently generating the sequence “1-0-2”).

By continually updating the belief state based on observed progress rewards, the system can adaptively switch strategies using the eliminated hypotheses until the optimal target sequence is successfully discovered. This reflective exploration mechanism can cause the generative neural network not simply memorize training sequences, but actively gathers information to reduce uncertainty, thereby enabling robust test-time generalization to novel tasks.

FIG. 3 is a flow diagram of an example process 300 for training a generative neural network to perform a reasoning task. For convenience, the process 300 will be described as being performed by a system of one or more computers located in one or more locations. For example, a training system, e.g., the training system 200 depicted in FIG. 1 and FIG. 2A, appropriately programmed in accordance with this specification, can perform the process 300.

The generative neural network trained by the process 300 can be a transformer-based neural network. Furthermore, before generating candidate reasoning trajectories in response to a prompt, the generative neural network can be a pre-trained model that has been pre-trained on text data to perform general language modeling tasks.

At 310, the system receives a prompt for the generative neural network. The prompt can include a text sequence, such as a natural language query or a mathematical word problem. In some implementations, the prompt can include multi-modal data, including two or more of text data, image data, audio data, video data, or sensor data. In other implementations, the prompt can be a prompt to perform a task within a software environment.

At 320, the system obtains a ground truth response to the prompt. The ground truth response can be a known, correct, or target output corresponding to the prompt, which can be retrieved from a curated dataset of training examples.

At 330, the system generates, using the generative neural network, a plurality of candidate reasoning trajectories in response to the prompt. Each candidate reasoning trajectory includes a respective sequence of reasoning steps generated sequentially, followed by a respective candidate response to the prompt. The generative neural network can be configured to generate natural language reasoning trajectories or to generate computer code. In some implementations, generating the plurality of candidate reasoning trajectories includes generating at least one candidate reasoning trajectory that includes reflective reasoning steps. To generate the reflective reasoning steps, the generative neural network generates a reasoning step that returns to a previous state in the candidate reasoning trajectory, and subsequently generates a reasoning step at the previous state that is different from the reasoning step previously generated at that state.

Depending on the prompt, the generated reasoning trajectories can take various forms. For a multi-modal prompt, at least one of the candidate reasoning trajectories can include one or more multi-modal reasoning steps, where at least one reasoning step includes data in a modality different from the modality of the prompt. For a prompt to perform a task within a software environment, the generative neural network can generate a reasoning trajectory that includes commands executable in the software environment to carry out the task. For instance, the reasoning trajectory can include a reasoning step that represents a call to an external software tool through an Application Programming Interface (API), followed by a subsequent reasoning step that includes an output received from the external software tool in response to the API call.

For each reasoning step in each of the plurality of candidate reasoning trajectories generated at 330, the system performs a series of evaluation steps (340, 350, and 360) to determine a posterior-weighted value for the step. At 340, the system determines a quality value for the current reasoning step in the candidate trajectory. The quality value measures an expected future reward for adding the current reasoning step to reasoning steps that precede the current reasoning step in the candidate reasoning trajectory. In some implementations, determining the quality value includes determining a first probability of the generative neural network for generating the candidate response given that the current reasoning step has been generated. The system also determines a second probability of the generative neural network for generating the candidate response without the current reasoning step having been generated. Furthermore, the system determines a verification reward value that measures a quality of the reasoning steps predicted by the generative neural network relative to the ground-truth response obtained at 320. The system then computes the quality value for the current reasoning step based on the first probability, the second probability, and the verification reward.

At 350, the system determines a first weighting factor. The first weighting factor is based on, for each of one or more of the reasoning steps that precede the current reasoning step in the candidate trajectory, a deviation of an observed progress reward from a predicted progress reward for the preceding reasoning step. The observed progress reward measures a change in a likelihood of the generative neural network generating the ground truth response to the prompt caused by adding the preceding reasoning step to the candidate reasoning trajectory. The predicted progress reward measures a change in a likelihood of the generative neural network generating the candidate response to the prompt caused by adding the preceding reasoning step.

In some implementations, the system additionally determines a second weighting factor. The second weighting factor is based on a likelihood of the generative neural network for generating the candidate response given the reasoning steps preceding the current reasoning step in the candidate reasoning trajectory.

At 360, the system computes a weighted quality value based at least on the quality value determined at 340 and the first weighting factor determined at 350. If a second weighting factor is utilized, the system computes the weighted quality value based on the quality value, the first weighting factor, and the second weighting factor. At 370, after processing the reasoning steps for the plurality of candidate reasoning trajectories, the system trains the generative neural network using the weighted quality values computed at 360. For example, the system can update the parameters of the generative neural network using a policy gradient algorithm that optimizes an objective function incorporating the weighted quality values computed for the plurality of reasoning steps.

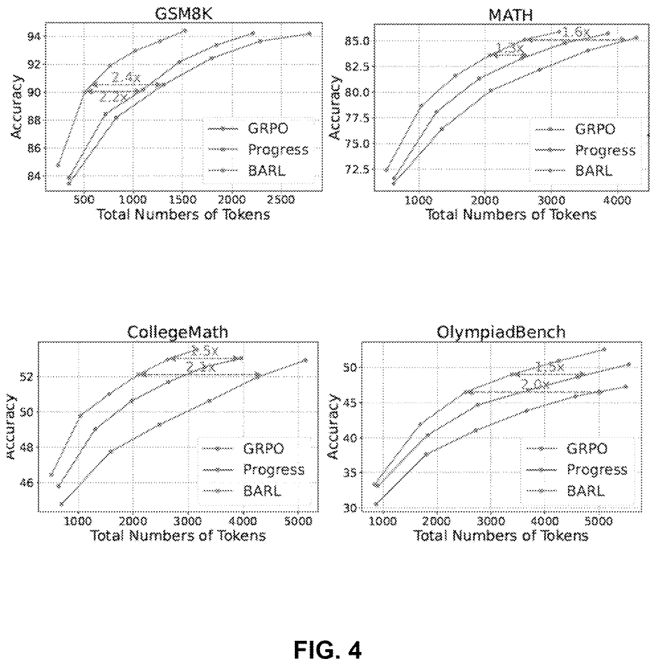

FIG. 4 illustrates the performance and token efficiency of the described Bayes-Adaptive reinforcement learning (BARL) framework compared to baseline techniques. The baseline techniques evaluated include an outcome-reward reinforcement learning baseline, such as Group Relative Policy Optimization (GRPO), and a process-reward reinforcement learning baseline, such as a model that integrates a progress reward into the outcome reward.

The charts in FIG. 4 evaluate token efficiency by plotting reasoning accuracies against the corresponding average total numbers of tokens required by the generative neural network to solve a problem. The evaluation is shown across multiple mathematical reasoning tasks and benchmarks, including GSM8K, MATH, CollegeMath, and OlympiadBench. The total number of tokens serves as a proxy for the computational cost and the efficiency of the generative neural network's reasoning process.

As shown in the charts, the generative neural network trained using the BARL framework consistently achieves higher reasoning accuracies while requiring substantially fewer total tokens compared to the baseline models. This improved token efficiency demonstrates that the described techniques produce more effective reasoning trajectories and thinking tokens. Under high sampling temperatures, baseline models can degenerate into generating a high frequency of merely stylistic or unproductive self-reflections, which consume large numbers of tokens without significantly improving the overall reasoning accuracy. In contrast, the generative neural network trained using the BARL framework leverages its updated internal belief states to perform highly efficient, uncertainty-adaptive exploration.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for training a generative neural network, the method being performed by one or more processors, comprising:
obtaining a prompt for the generative neural network;
obtaining a ground truth response to the prompt;
obtaining, using the generative neural network, a plurality of candidate reasoning trajectories generated using the generative neural network in response to the prompt, each candidate reasoning trajectory comprising a respective sequence of reasoning steps followed by a respective candidate response to the prompt;
for each reasoning step in each of the plurality of candidate trajectories:
determining a quality value for the current reasoning step in the candidate trajectory, wherein the quality value measures an expected future reward for adding the current reasoning step to reasoning steps that precede the current reasoning step in the candidate reasoning trajectory;
determining a first weighting factor based on, for each of one or more of the reasoning steps that precede the current reasoning step in the candidate trajectory, a deviation of an observed progress reward from a predicted progress reward for the preceding reasoning step, wherein the observed progress reward measures a change in a likelihood of the generative neural network generating the ground truth response to the prompt caused by adding the preceding reasoning step to the candidate reasoning trajectory, and the predicted progress reward measures a change in a likelihood of the generative neural network generating the candidate response to the prompt caused by adding the preceding reasoning step; and
computing a weighted quality value based at least on the quality value and the first weighting factor; and
training the generative neural network using the weighted quality values computed for the plurality of reasoning steps in the plurality of candidate trajectories.

2. The method of claim 1, wherein determining the quality value for the current reasoning step in the candidate trajectory comprises:
determining a first probability of the generative neural network for generating the candidate response given that the current reasoning step has been generated;
determining a second probability of the generative neural network for generating the candidate response without the current reasoning step having been generated;
determining a verification reward value that measures a quality of reasoning steps predicted by the generative neural network relative to the ground-truth response; and
computing the quality value based on the first probability, the second probability, and the verification reward.

3. The method of claim 1, wherein computing the weighted quality value further comprises:
determining a second weighting factor based on a likelihood of the generative neural network for generating the candidate response given the reasoning steps preceding the current reasoning step in the candidate reasoning trajectory; and
computing the weighted quality value based on the quality value, the first weighting factor, and the second weighting factor.

4. The method of claim 1, wherein generating the plurality of candidate reasoning trajectories comprises:
generating at least one candidate reasoning trajectory that includes reflective reasoning steps, wherein generating the reflective reasoning steps comprises:
generating a reasoning step that returns to a previous state in the candidate reasoning trajectory; and
generating a subsequent reasoning step at the previous state that is different from the reasoning step previously generated at that state.

5. The method of claim 1, wherein the generative neural network is configured to generate computer code.

6. The method of claim 1, wherein the generative neural network is configured to generate natural language reasoning trajectories.

7. The method of claim 1, wherein the prompt comprises multi-modal data, including two or more of text data, image data, audio data, video data, or sensor data.

8. The method of claim 1, wherein at least one of the candidate reasoning trajectories comprises one or more multi-modal reasoning steps, wherein at least one reasoning step comprises data in a modality different from the modality of the prompt.

9. The method of claim 1, wherein the generative neural network is configured to:
receive a prompt to perform a task within a software environment; and
generate a reasoning trajectory that includes commands executable in the software environment to carry out the task.

10. The method of claim 9, wherein the reasoning trajectory comprises:
a reasoning step that comprises a call to an external software tool through an Application Programming Interface (API); and
a subsequent reasoning step that comprises an output received from the external software tool in response to the API call.

11. The method of claim 1, wherein the generative neural network comprises a transformer-based neural network.

12. The method of claim 1, wherein before generating the candidate reasoning trajectories in response to the prompt, the generative neural network has been pre-trained on text data to perform general language modeling tasks.

13. A system comprising:
one or more computers; and
one or more storage devices storing instructions that when executed by the one or more computers, cause the one or more computers to perform the operations for training a generative neural network, the operations comprising:
receiving a prompt for the generative neural network;
obtaining a ground truth response to the prompt;
generating, using the generative neural network, a plurality of candidate reasoning trajectories in response to the prompt, each candidate reasoning trajectory comprising a respective sequence of reasoning steps followed by a respective candidate response to the prompt;
for each reasoning step in each of the plurality of candidate trajectories:
determining a quality value for the current reasoning step in the candidate trajectory, wherein the quality value measures an expected future reward for adding the current reasoning step to reasoning steps that precede the current reasoning step in the candidate reasoning trajectory;
determining a first weighting factor based on, for each of one or more of the reasoning steps that precede the current reasoning step in the candidate trajectory, a deviation of an observed progress reward from a predicted progress reward for the preceding reasoning step, wherein the observed progress reward measures a change in a likelihood of the generative neural network generating the ground truth response to the prompt caused by adding the preceding reasoning step to the candidate reasoning trajectory, and the predicted progress reward measures a change in a likelihood of the generative neural network generating the candidate response to the prompt caused by adding the preceding reasoning step; and
computing a weighted quality value based at least on the quality value and the first weighting factor; and
training the generative neural network using the weighted quality values computed for the plurality of reasoning steps in the plurality of candidate trajectories.

14. The system of claim 13, wherein determining the quality value for the current reasoning step in the candidate trajectory comprises:
determining a first probability of the generative neural network for generating the candidate response given that the current reasoning step has been generated;
determining a second probability of the generative neural network for generating the candidate response without the current reasoning step having been generated;
determining a verification reward value that measures a quality of reasoning steps predicted by the generative neural network relative to the ground-truth response; and
computing the quality value based on the first probability, the second probability, and the verification reward.

15. The system of claim 13, wherein computing the weighted quality value further comprises:
determining a second weighting factor based on a likelihood of the generative neural network for generating the candidate response given the reasoning steps preceding the current reasoning step in the candidate reasoning trajectory; and
computing the weighted quality value based on the quality value, the first weighting factor, and the second weighting factor.

16. The system of claim 13, wherein generating the plurality of candidate reasoning trajectories comprises:
generating at least one candidate reasoning trajectory that includes reflective reasoning steps, wherein generating the reflective reasoning steps comprises:
generating a reasoning step that returns to a previous state in the candidate reasoning trajectory; and
generating a subsequent reasoning step at the previous state that is different from the reasoning step previously generated at that state.

17. One or more computer-readable storage media storing instructions that, when executed by one or more computers, cause the one or more computers to perform the operations for training a generative neural network, the operations comprising:
receiving a prompt for the generative neural network;
obtaining a ground truth response to the prompt;
generating, using the generative neural network, a plurality of candidate reasoning trajectories in response to the prompt, each candidate reasoning trajectory comprising a respective sequence of reasoning steps followed by a respective candidate response to the prompt;
for each reasoning step in each of the plurality of candidate trajectories:
determining a quality value for the current reasoning step in the candidate trajectory, wherein the quality value measures an expected future reward for adding the current reasoning step to reasoning steps that precede the current reasoning step in the candidate reasoning trajectory;
determining a first weighting factor based on, for each of one or more of the reasoning steps that precede the current reasoning step in the candidate trajectory, a deviation of an observed progress reward from a predicted progress reward for the preceding reasoning step, wherein the observed progress reward measures a change in a likelihood of the generative neural network generating the ground truth response to the prompt caused by adding the preceding reasoning step to the candidate reasoning trajectory, and the predicted progress reward measures a change in a likelihood of the generative neural network generating the candidate response to the prompt caused by adding the preceding reasoning step; and
computing a weighted quality value based at least on the quality value and the first weighting factor; and
training the generative neural network using the weighted quality values computed for the plurality of reasoning steps in the plurality of candidate trajectories.

18. The computer-readable storage media of claim 17, wherein determining the quality value for the current reasoning step in the candidate trajectory comprises:
determining a first probability of the generative neural network for generating the candidate response given that the current reasoning step has been generated;
determining a second probability of the generative neural network for generating the candidate response without the current reasoning step having been generated;
determining a verification reward value that measures a quality of reasoning steps predicted by the generative neural network relative to the ground-truth response; and
computing the quality value based on the first probability, the second probability, and the verification reward.

19. The computer-readable storage media of claim 17, wherein computing the weighted quality value further comprises:
determining a second weighting factor based on a likelihood of the generative neural network for generating the candidate response given the reasoning steps preceding the current reasoning step in the candidate reasoning trajectory; and
computing the weighted quality value based on the quality value, the first weighting factor, and the second weighting factor.

20. The computer-readable storage media of claim 17, wherein generating the plurality of candidate reasoning trajectories comprises:
generating at least one candidate reasoning trajectory that includes reflective reasoning steps, wherein generating the reflective reasoning steps comprises:
generating a reasoning step that returns to a previous state in the candidate reasoning trajectory; and
generating a subsequent reasoning step at the previous state that is different from the reasoning step previously generated at that state.
